(19) United States
(12) Patent Application Publication
(10) Pub. No.: US 2005/0178041 A1
(43) Pub. Date: Aug. 18, 2005

(54) Johnny boy rod holders

(76) Inventor: John Santo Zaffiro, West Allis, WI (US)

Correspondence Address: JOHN ZAFFIRO, 12016 W. CLEVELAND AVE, WEST ALLIS, WI, 53227, US

(21) Appl. No.: 10/934,933

(22) Filed: Feb. 12, 2004

(51) Int. Cl. A01K 97/10

(52) U.S. Cl. 43/21.2

(57) ABSTRACT

An article of manufacture for multiple, height adjustable rod holders, comprising: two bases which screw into pier, vertical support bars, height adjustable cross bar for ease of use by adults or children, and 3 or more rod holders on one platform. The rod holders will accomodate all varieties of fishing rods. The rod holder system is designed to be used specifically on piers with the possibility of use on boats. Adjustable in height without tools. Cross bar can be removed by pulling two pins and the vertical supports can be unscrewed by hand from the bases in under 30 seconds. This would leave only the ½″ tall bases on the mounting surface (pier). This would leave the end of the pier completely open for swimming or boating activities. Additional bases could be purchased separately for multiple use of system on same pier or additional pier. Permanent mounting is an option.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of fishing and more specifically to an article of manufacture for multiple, height adjustable rod holders. Rod holders are used to secure fishing rods to the end of a pier or on a boat. This is to prevent a striking fish from pulling the rod into the water. Single rod holders are permanently attached to the end of a pier causing loss of the use of the end of the pier. Current technology is by permanent attachment to the pier. Current technology is for single rod holders.

This application can be easily and quickly adjusted for use by small children or adults. It could also double as a railing at the end of the pier. Older adults and children can often feel apprehensive at the end of a pier when there is nothing in front of them. This system can be partially removed by pulling the pins and lifting out the crossbar leaving only the vertical supports or it can be completely removed by unscrewing the vertical supports leaving only the mounting bases. This can all be accomplished in approximately 15 seconds without the use of any tools, leaving the end of the pier open for swimming or boating activities or to prevent theft. Entire system weighs approximately 5 pounds.

### BRIEF SUMMARY OF THE INVENTION

The primary object of the invention is to provide three or more rod holders on one platform.

Another object of the invention is ease of Installation by using only a screw driver.

Another object of the invention is ease of height adjustment by use of locking pins.

Another object of the invention is ease of partial or complete removal in under 30 seconds without tools.

Another object of the invention is a universal tube which holds a variety of rods.

Another object of the invention is materials will not rust and if desired permanent installation could be accomplished.

Another object of the invention is it can be easily removed for end of pier use and to prevent theft.

A further object of the invention is installation of multiple bases for use with the system.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for multiple, height adjustable rod holders, comprising: two bases which screw into pier, vertical support bars, height adjustable cross bar, and 3 or more rod holders on one platform.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1: shows front, side and top views and the dotted lines show the vertical adjustment possibilities.

FIG. 2: Plain view of invention

FIG. 3: Shows parts of invention and how invention is put together.

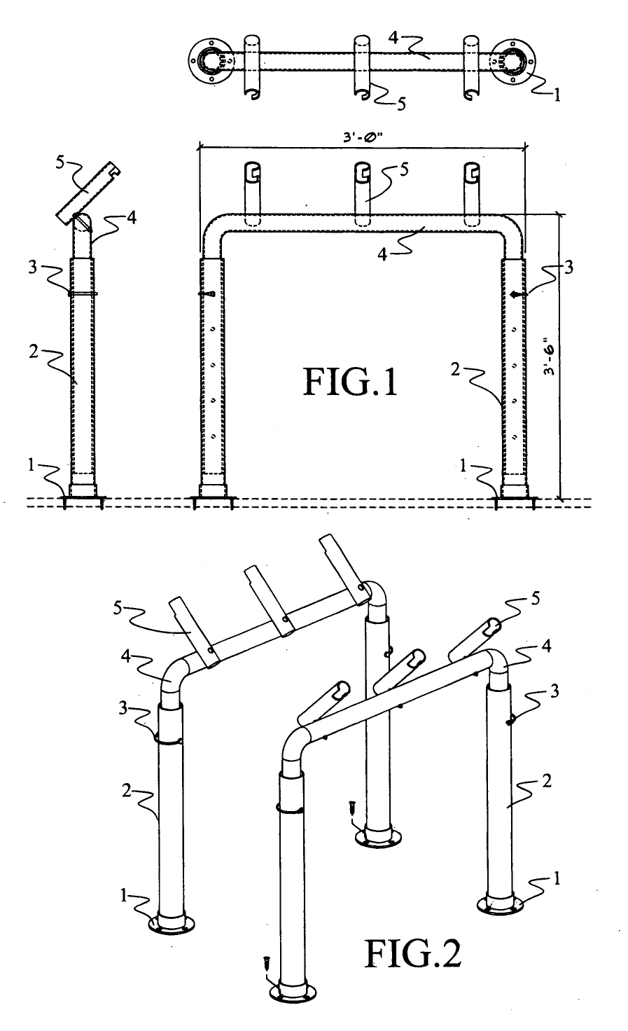

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

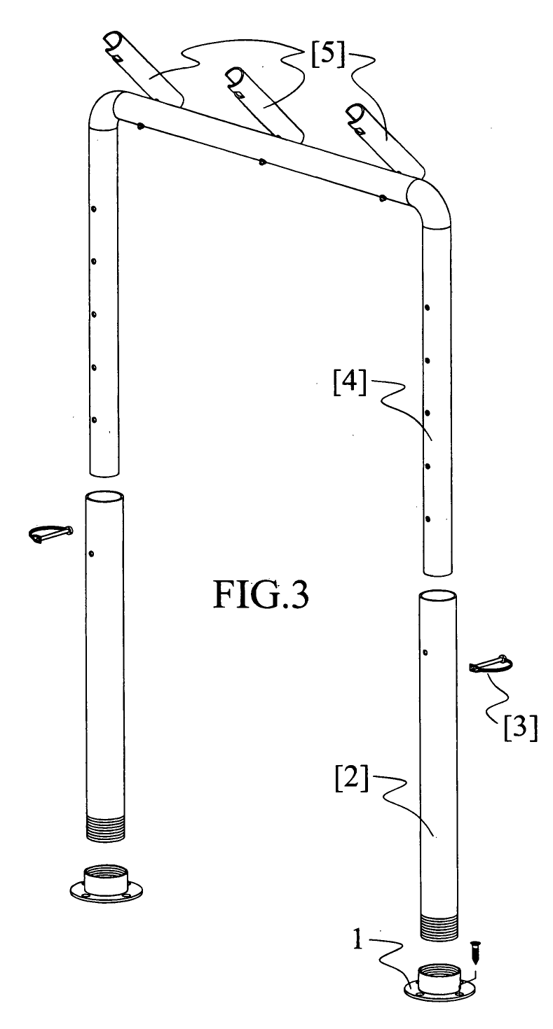

Turning first to FIG. 3 there is shown two threaded bases which mount to a pier (1). They are round, five inches in diameter and have four ⅜″ mounting holes and is ¾″ in height. These would be preferably made out of steel but plastic or aluminum could be used. These would be secured to a pier using wood screws or bolts with a lock washer and nut. Length of mounting screws or bolts would depend on the thickness of the surface where rod holder is mounted. Then two vertical supports (2) screw in by hand to the mounted bases. Next an adjustable cross bar (4) is installed with the use of locking pins (3). The holes in the crossbar are ¼″ in diameter with; a distance between holes of 6″. The actual rod holder (5) is 9″ long, 1-½″ in diameter and is notched at the top end to prevent the fishing rod from being pulled out by a fish. Rod holder (5) is attached to crossbar (4) by a 2-¾″ long bolt, lockwasher and nut. When all parts are installed an article of manufacture for an easily removable, height adjustable, multiple rod holder system is accomplished. This system will support three or more rod holders.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An article of manufacture for multiple, height adjustable rod holders. Comprising:
Two bases which screw into pier;
Vertical support bars;
Height adjustable cross bar; and
3 or more rod holders on one platform.
